(19) United States
(12) Patent Application Publication
(10) Pub. No.: US 2008/0282925 A1
(43) Pub. Date: Nov. 20, 2008

(54) ELECTRONIC BLASTING WITH HIGH ACCURACY

(75) Inventors: Charles Michael LOWNDS, Aurora, CO (US); Ronald F. STEWART, Ottawa (CA); Dirk Hummel, Hennef (DE)

Correspondence Address: KIRBY EADES GALE BAKER, BOX 3432, STATION D, OTTAWA, ON, K1P 6N9, CA

(73) Assignee: ORICA EXPLOSIVES TECHNOLOGY PTY LTD, Melbourne (AU)

(21) Appl. No.: 12/120,635

(22) Filed: May 14, 2008

Related U.S. Application Data
(60) Provisional application No. 60/924,448, filed on May 15, 2007.

(51) Int. Cl. F42D 3/04; F23Q 21/00; G01V 1/28

(52) U.S. Cl. 102/311; 102/215; 702/14

(57) ABSTRACT

Electronic blasting systems typically permit blasting with detonator delay times having millisecond accuracy. Disclosed herein are blasting apparatuses and methods of blasting that are capable of even higher degrees of delay time accuracy, for example involving programmable delay times selectable to an accuracy of about 0.25 ms, 0.1 ms, or better. Such methods and apparatuses present unprecedented and unexpected advantages for both mining applications, civil engineering uses, and in seismic prospecting.

### CROSS-REFERENCE TO RELATED APPLICATION

This application claims the priority right of U.S. Patent Application 60/924,448 filed May 15, 2007 by Applicants herein.

### FIELD OF THE INVENTION

The present invention relates to the field of blasting for mining or seismic operations. In particular, the invention relates to the field of electronic blasting using electronic detonators.

### BACKGROUND TO THE INVENTION

The efficient fragmentation and breaking of rock by means of explosive charges demands considerable skill and expertise. In most mining operations explosive charges, including boosters, are placed at predetermined positions near or within the rock, for example within boreholes drilled into the rock. The explosive charges are then actuated via detonators having predetermined time delays, thereby providing a desired pattern of blasting and rock fragmentation. Traditionally, signals are transmitted to the detonators from an associated blasting machine via non-electric systems employing low energy detonating cord (LEDC) or shock tube. Alternatively, electrical wires may be used to transmit more sophisticated signals to and from electronic detonators. For example, such signalling may include ARM, DISARM, and delay time instructions for remote programming of the detonator firing sequence. Moreover, as a security feature, detonators may store firing codes and respond to ARM and FIRE signals only upon receipt of matching firing codes from the blasting machine. Electronic detonators are often programmed with time delays with an accuracy no better than 1 ms.

Typically, explosive charges are positioned in rock in rows, with slight delays (for example in the order of a few milliseconds) between actuation of the charges in adjacent rows. This has the effect of generating a progressively moving shock wave in the rock having a compressive phase suitable both to (1) fragment the rock, and (2) move the fragmented rock in a desired direction. Typically the compressive phase may last a few milliseconds. Therefore, depending upon timing, the shock waves emanating from a particular explosive charge, or a particular row of explosive charges, may interfere with shock waves emanating from adjacent explosive charges, or rows of explosive charges. This interference may lead to unwanted ground vibrations. However, in some cases the interference of shockwaves may have desirable consequences, such as increased rock fragmentation. In one example, International Patent Publication WO2005/124,272 published Dec. 29, 2005, which is incorporated herein by reference, teaches methods for blasting that involve interference between shockwaves from adjacent boreholes, whilst the timing of initiation of explosive charges is intended to help reduce overall ground vibrations.

Seismic prospecting can also encompass analysis of shockwave interference, for shockwaves derived from actuation of explosive charges. Typically, the explosive charges are spaced metres apart, or perhaps even hundreds or thousands of metres apart. Moreover, for seismic purposes the explosive charges are typically actuated simultaneously. Subsequent analysis of shockwave reflection, interference, and dissipation, can provide those skilled in the art with valuable data regarding rock strata or the presence of oil or gas deposits beneath the surface of the earth or sea.

At this time, the most precise blast initiation devices that are widely, commercially available include electronic detonators. Such electronic detonators can be programmed with delay times with a degree of accuracy typically to the whole 1 ms. This degree of accuracy is convenient and familiar to those skilled in the art, who design blasting events within the parameters of 1 ms timing accuracy. Nonetheless, there remains a need in the art for improvements to the safety, and effectiveness of blasting systems, whether applied to rock fragmentation for mining, or seismic operations.

### SUMMARY OF THE INVENTION

It is one object of the present invention, at least in preferred embodiments, to provide an electronic detonator, or a blasting apparatus involving an electronic detonator, that exhibits improved accuracy over the electronic detonators and blasting apparatuses of the prior art.

It is another object of the invention, at least in preferred embodiments, to provide a method of blasting in which electronic detonators are actuated with an improved degree of accuracy.

Certain exemplary embodiments provide a blasting apparatus, for executing a blast plan for at least two detonators each programmable with a delay time selectable to an accuracy of about 0.1 ms or better, the blasting apparatus comprising:

(a) at least one blasting machine for transmitting at least one command signal to at least two associated detonators, at least including a FIRE signal;

(b) at least two detonators, each comprising:
i) a base charge;
ii) a firing circuit selectively connectable to the base charge;
iii) energy storage means for storing energy for initiation of the base charge via the firing circuit;
iv) an oscillator having a fixed and stable or calibratable frequency of at least about 10 kHz;
v) memory means for storing a delay time corresponding to a number of counts of said oscillator;
vi) a receiver for receiving said at least one command signal from said blasting machine;

whereby upon receipt by said receiver of said FIRE signal, said oscillator commences a count down of said number of counts, and upon completion of said countdown said energy storage means discharges said energy stored therein into said firing circuit to initiate said base charge.

Certain other exemplary embodiments provide a detonator assembly comprising:

i) a base charge;

ii) a firing circuit selectively connectable to the base charge;

iii) energy storage means for storing energy for initiation of the base charge via the firing circuit;

iv) an oscillator having a fixed and stable or calibratable frequency of at least about 10 kHz;

v) memory means for storing a delay time corresponding to a number of counts of said oscillator;

vi) a receiver for receiving said at least one command signal from an associated blasting machine;

whereby upon receipt by said receiver of said FIRE signal from an associated blasting machine, said oscillator commences a count down of said number of counts, and upon completion of said countdown said energy storage means discharges said energy stored therein into said firing circuit to initiate said base charge.

Certain other exemplary embodiments provide a wireless electronic booster, comprising:

the detonator assembly described above, wherein said receiver receives wireless command signals from an associated blasting machine;

an explosive charge actuable upon initiation of the base charge of the detonator;

a housing for containing the detonator assembly and the explosive charge.

Certain other exemplary embodiments provide a method of blasting, comprising the steps of:

(1) providing a blasting apparatus as described above;

(2) placing the at least two detonators at the blast site;

(3) programming the at least two detonators with delay times selectable to an accuracy of about 0.1 ms or better, said delay times being stored in each memory means as a number of counts for each corresponding oscillator;

(4) transmitting a command signal to FIRE from each of said at least one blasting machine to said at least two detonators, thereby causing each oscillator to count down its respective number of counts upon completion of which an associated base charge is initiated;

wherein steps (2) and (3) may be performed in any order or simultaneously.

Certain other exemplary embodiments provide a seismic assessment apparatus for seismic assessment of subterranean geology or structure, the apparatus including:

(a) at least one blasting machine for communicating at least one command signal to at least one associated detonator, at least including a FIRE signal;

(b) at least one detonator, each comprising:
i) a base charge;
ii) a firing circuit selectively connectable to the base charge;
iii) energy storage means for storing energy for initiation of the base charge via the firing circuit;
iv) an oscillator having a fixed and stable or calibratable frequency of at least about 10 kHz;
v) memory means for storing a delay time corresponding to a number of counts of said oscillator;
vi) a receiver for receiving said at least one command signal from said blasting machine;

whereby upon receipt by said receiver of said FIRE signal, each oscillator commences a count down of said number of counts, and upon completion of said countdown said energy storage means discharges said energy stored therein into said firing circuit to initiate said base charge, so that initiation of each of the at least one detonator causes shockwaves through or incident to said subterranean geology or structure, as well as shockwaves reflected or refracted by said subterranean geology or structure, said shockwaves optionally interfering with one another; and

(c) at least one shockwave receiver for receiving said shockwaves transmitted through or incident to said subterranean geology or structure, or shockwaves reflected or refracted by said subterranean geology or structure, thereby to permit collation of data indicative of said subterranean geology or structure.

Certain other exemplary embodiments provide a method for seismic analysis of subterranean geology or structure, the method comprising the steps of:

(1) providing a seismic assessment apparatus as described above;

(2) placing the at least one detonator at the blast site;

(3) programming each of the at least one detonator with a delay time selectable to an accuracy of about 0.1 ms or better, said delay times being stored in each memory means as a number of counts for each corresponding oscillator;

(4) transmitting a command signal to FIRE from each of said at least one blasting machine to said at least one detonator, thereby causing each oscillator to count down its respective number of counts upon completion of which an associated base charge is initiated; and

(5) collecting data via said at least one shockwave receiver, corresponding to said shockwaves transmitted through or incident to said subterranean geology or structure, and/or shockwaves reflected or refracted by said subterranean geology or structure indicative of said subterranean geology or structure;

wherein steps (2) and (3) may be performed in any order or simultaneously.

Certain other exemplary embodiments provide a method for fragmenting rock drilled with boreholes, the method comprising the steps of:

(1) inserting into each borehole an explosive material and an associated electronic detonator such that initiation of a base charge in the detonator causes detonation of the explosive material;

(2) programming each electronic detonator with a delay time having an accuracy of about 0.1 ms or better;

(3) sending a signal to all detonators to begin countdown of their programmed delay times to cause initiation of the detonators and detonation of the explosive materials in the boreholes, the delay times being programmed in such a manner that shockwaves resulting from detonation of the explosive materials interfere to cause efficient fragmentation of rock located between or near the boreholes;

wherein steps 1 and 2 may be performed in any order.

### BRIEF DESCRIPTION OF THE DRAWINGS

FIG. 1 schematically illustrates a front-elevational view of a portion of rock to be blasted for the purposes of tunnelling, with boreholes shown.

FIG. 2 schematically illustrates a top-plan view of rows of boreholes in rock for blasting.

FIG. 3 provides a graph to schematically illustrate a relationship between burden of interhole delay in ms per m of spacing of boreholes (x-axis) and rock size following fragmentation from blasting (y-axis).

### DEFINITIONS

‘Actuate’ or ‘initiate’—refers to the initiation, ignition, or triggering of explosive materials, typically by way of a primer, detonator or other device capable of receiving an external signal and converting the signal to cause deflagration of the explosive material.

‘About’—generally precedes a stated parameter to indicate that the parameter may be flexible relative to what is actually stated. For example “about 0.1 ms” includes “0.1 ms +/−25%”, “0.1 ms +/−10%”, and “0.1 ms +/−1%”. Likewise, “at least about 10 kHz” includes “at least 10 kHz +/−25%”, “at least 10 kHz +/−10%”, and “at least 10 kHz +/−1%”. Further parameter variation other than those stated herein may also be encompassed by the term ‘about’ depending upon context.

‘Automated/automatic blasting event’—encompasses all methods and blasting systems that are amenable to establishment via remote means for example employing robotic systems at the blast site. In this way, blast operators may set up a blasting system, including an array of detonators and explosive charges, at the blast site from a remote location, and control the robotic systems to set-up the blasting system without need to be in the vicinity of the blast site.

‘Base charge’—refers to any discrete portion of explosive material in the proximity of other components of the detonator and associated with those components in a manner that allows the explosive material to actuate upon receipt of appropriate signals from the other components. The base charge may be retained within the main casing of a detonator, or alternatively may be located nearby the main casing of a detonator. The base charge may be used to deliver output power to an external explosives charge to initiate the external explosives charge.

‘Blasting machine’—any device that is capable of being in signal communication with electronic detonators, for example to send ARM, DISARM, and FIRE signals to the detonators, and/or to program the detonators with delay times and/or firing codes. The blasting machine may also be capable of receiving information such as delay times or firing codes from the detonators directly, or this may be achieved via an intermediate device to collect detonator information and transfer the information to the blasting machine, such as a logger.

‘Booster’—refers to any device of the present invention that can receive wireless command signals from an associated blasting machine, and in response to appropriate signals such as a wireless signal to FIRE, can cause actuation of an explosive charge that forms an integral component of the booster. In this way, the actuation of the explosive charge may induce actuation of an external quantity of explosive material, such as material charged down a borehole in rock. In selected embodiments, a booster may comprise the following non-limiting list of components: a detonator comprising a firing circuit and a base charge; an explosive charge in operative association with said detonator, such that actuation of said base charge via said firing circuit causes actuation of said explosive charge; a transceiver for receiving and processing said at least one wireless command signal from said blasting machine, said transceiver in signal communication with said firing circuit such that upon receipt of a command signal to FIRE said firing circuit causes actuation of said base charge and actuation of said explosive charge.

‘Borehole’—generally refers to an elongate hole or recess, preferably cylindrical in form, drilled into a section of rock for loading, for example, explosive materials and initiation primers for actuating the explosive materials. However, boreholes may take any shape or form that is amenable to receiving explosive materials.

‘Burden’—refers to a thickness of rock between a nearby borehole or row of boreholes (into which an explosive charge or charges may be loaded) and the free surface or face of rock for example formed from a previous blasting event. A burden may also be referred to as a thickness of rock to be removed by a blasting event such as the detonation of an explosive charge in a borehole or row of boreholes.

‘Central command station’—refers to any device that transmits signals via radio-transmission or by direct connection, to one or more blasting machines. The transmitted signals may be encoded, or encrypted. Typically, the central blasting station permits radio communication with multiple blasting machines from a location remote from the blast site.

‘Charge/charging’—refers to a process of supplying electrical power from a power supply to an energy storage device, with the aim of increasing an amount of electrical charge or energy stored by the energy storage device. As desired in preferred embodiments, the charge in the energy storage device surpasses a threshold sufficiently high such that discharging of the energy storage device via a firing circuit causes actuation of a base charge associated with the firing circuit.

‘Clock’—encompasses any clock suitable for use in connection with a blasting apparatus and detonator or detonator assembly of the invention, for example to time delay times for detonator actuation during a blasting event. In particularly preferred embodiments, the term clock relates to a crystal clock, for example comprising an oscillating quartz crystal of the type that is well know, for example in conventional quartz watches and timing devices. Crystal clocks may provide particularly accurate timing in accordance with preferred aspects of the invention.

‘Conversion means’—refers to any hardware or software component that receives information regarding a specific delay time for a detonator, and converts the delay time into a number of oscillation counts for a clock associated with the detonator, according to the speed of the clock.

‘Detonator’—refers to any detonator that includes a base charge actuatable upon receipt by the detonator of a command signal to FIRE. Typically a detonator will include a detonator shell for retaining the base charge and other components of the detonator if present. Such other components may include means to receive and/or process incoming command signals, or optionally memory means to store data including but not limited to: detonator identification codes, firing times, delay times, anti-collision response times etc. The term “detonator” may be interchanged with “detonator assembly” if appropriate.

‘Detonator assembly’—refers to any assembly that comprises a detonator (comprising in its minimal form a base charge actuatable upon receipt by the detonator of a command signal to FIRE) together with at least one other component. Such other components may include, but are not limited to: means to receive and/or process incoming command signals, or optionally memory means to store data including but not limited to: detonator identification codes, firing times, delay times, anti-collision response times etc., a booster housing, a booster explosive charge, an explosive charge, a transmitter, a receiver, a transceiver etc. Depending upon context the expression “detonator assembly” may be interchanged with “detonator” if appropriate.

‘Energy storage means’—refers to any device capable of storing electric charge or energy. Such a device may include, for example, a capacitor, diode, rechargeable battery or activatable battery. At least in preferred embodiments, the potential difference of electrical energy used to charge the energy storage device is less or significantly less than the potential difference of the electrical energy upon discharge of the energy storage device into a firing circuit. In this way, the energy storage device may act as a voltage multiplier, wherein the device enables the generation of a voltage that exceeds a predetermined threshold voltage to cause actuation of a base charge connected to the firing circuit.

‘Explosive charge’ or ‘Explosive material’—includes an discreet portion of an explosive substance contained for example or substantially contained within a borehole. The explosive charge is typically of a form and sufficient size to receive energy derived from the actuation of a base charge of a detonator, thereby to cause ignition of the explosive charge. Where the explosive charge is located adjacent or near to a further quantity of explosive material, such as for example explosive material charged into a borehole in rock, then the ignition of the explosive charge may, under certain circumstances, be sufficient to cause ignition of the entire quantity of explosive material, thereby to cause blasting of the rock. The chemical constitution of the explosive charge may take any form that is known in the art, most preferably the explosive charge may comprise TNT or pentolite.

‘Ground vibrations’—refer to unwanted vibrations in and around a blast site that sometimes do not contribute to rock fragmentation or fracture or to seismic analysis. Such ground vibrations can lead to unwanted disruption of rock or subterranean structures and strata giving rise to safety concerns. Excessive ground vibrations may be caused, for example, by positive interference of shockwaves propagated from explosive charges in multiple boreholes at substantially the same time, or at a similar time.

‘Interference’ or ‘interaction’—refers to the interaction of at least some shockwaves originating from different sources (e.g. from the same borehole or from different boreholes) or from the same original source (e.g. shockwaves originating from detonation of a single explosive charge, but reflected and refracted by underground structures) to give rise to improved disruption, fragmentation or fracture of rock between or near the boreholes. For example, shockwaves may cooperate to give rise to shear forces to help further enhance rock breakage and disruption.

Wave interaction is also used in seismic surveying to help map underground structures. Interference of shock waves does not only refer to collision of the compressive parts of two shock waves. It may be found that benefits are achieved by having the compressive part of a first shock wave interact with the shear wave trailing a second shock wave. Alternatively, blast timing may be designed so as to avoid, but only just, the interaction of the compressive parts of two shock waves. Alternatively, it may be desirable to arrange for a second shock wave to interact at a specific point in the development of the fracture pattern following a first shock wave.

‘Logger/Logging device’—includes any device suitable for recording information with regard to components of the blasting apparatus of the present invention, such detonators. The logger may transmit or receive information to or from the components. For example, the logger may transmit data to detonators such as, but not limited to, detonator identification codes, delay times, synchronization signals, firing codes, positional data etc. Moreover, the logger may receive information from a detonator including but not limited to, detonator identification codes, delay times, information regarding the environment or status of the detonator, information regarding the capacity of the detonator to communicate with an associated blasting machine. Preferably, the logging device may also record additional information such as, for example, identification codes for each detonator, information regarding the environment of the detonator, the nature of the explosive charge in connection with the detonator etc. In selected embodiments, a logging device may form an integral part of a blasting machine, or alternatively may pertain to a distinct device such as for example, a portable programmable unit comprising memory means for storing data relating to each detonator, and preferably means to transfer this data to a central command station or one or more blasting machines. One principal function of the logging device, is to read the detonator so it can subsequently be “found” by an associated blasting machine, and have commands such as FIRE commands directed to it as appropriate. A logger may communicate with a detonator either by direct electrical connection (interface) or a wireless connection of any type.

‘Memory means’—refers to any hardware or software component that is capable or storing, either on a temporary, semi-permanent, or permanent basis, a data package. For example, a memory means of a detonator or detonator assembly as disclosed herein may be associated with a specific detonator, and store detonator identification and/or delay time information specific for or programmed into the detonator or detonator assembly.

‘Oscillator’—refers to any electronic device capable of generating a recurring waveform such as an alternating current or voltage, or a digital process used by a synthesizer to generate the same. Such an oscillator may include any type of clock, crystal device, or ceramic resonator, and the rate of oscillation may be set or selected according to a desired rate for a particular application. In accordance with the oscillators used in various embodiments of the present invention, the rate of oscillation may be in excess of 5 kHz, about 10 kHz, or greater than 10 kHz, or greater than 20 kHz, or greater than 40 kHz.

‘Preferably’—identifies preferred features of the invention. Unless otherwise specified, the term preferably refers to preferred features of the broadest embodiments of the invention, as defined for example by the independent claims, and other inventions disclosed herein.

Receiver: refers to any device that can receive and/or transmit signals (whether received via wired or wireless connection). Although the term “receiver” traditionally encompasses a device that can only receive signals, a receiver when used in accordance with the present invention includes a device that can function as both a receiver and transmitter of signals. For example, under specific circumstances the receiver may be located in a position where it is able to receive signals from a source, but not able to transmit signals back to the source or elsewhere. In very specific embodiments, where the receiver forms part of a booster or wireless detonator assembly located underground, the receiver may be able to receive signals through-rock from a wireless source located above a surface of the ground, but be unable to transmit signal back through the rock to the surface. In these circumstances the receiver optionally may have any signal transmission function disabled or absent. In other embodiments, the receiver may transmit signals only to a logger via direct electrical connection, or alternatively via short-range wireless signals. In other embodiments, a receiver may comprise a memory for storing a delay time, and may be programmable with a delay time (this is especially useful when the detonator and components thereof are not programmable, as may be the case for example with a non-electric electric, or selected pyrotechnic detonator).

‘Rock’ includes all types of rock, including shale etc.

‘Selectable to an accuracy of X ms or better’—refers to delay times selectable in accordance with the blasting apparatuses, components thereof, and methods of the present invention, which are selectable with a high degree of accuracy. For example, delay times may be selected and programmed with an accuracy to the nearest tenth of a millisecond or even better, including for example an accuracy to the nearest twentieth, fiftieth, or hundredth of a millisecond. For complete clarity, the term “better” in this context refers to an even smaller time period (i.e. an even high degree of temporal resolution) relative to the millisecond amount actually specified. Therefore, the expression “an accuracy of 0.1 ms or better” would encompass a delay time programmed to the nearest 0.1 ms, a delay time programmed to the nearest 0.05 ms, and a delay time programmed to the nearest 0.01 ms.

‘Shockwave’—refers to a spreading, abrupt but steady change in density, pressure, and/or temperature of material (e.g. rock) to be blasted. Such a shockwave may develop when a large amount of energy is released, for example by initiation of a quantity of explosive material, such as explosive material located in a borehole in rock, with the help of an electronic detonator. The forefront of this spreading energy represents a shockwave. A shockwave may also be considered a compression wave whose velocity exceeds a normal speed of sound in a medium such as rock, or a compression wave propagating pressure at well above the strength of a material in which the shockwave is propagating and therefore giving a very steep pressure rise in which viscous effects and thermal conductivity lead to an increase in entropy.

‘Top-box’—refers to any device forming part of a wireless detonator assembly that is adapted for location at or near the surface of the ground when the wireless detonator assembly is in use at a blast site in association with a bore-hole and explosive charge located therein. Top-boxes are typically located above-ground or at least in a position in, at or near the borehole that is more suited to receipt and transmission of wireless signals, and/or for relaying these signals to the detonator down the borehole. In preferred embodiments, each top-box comprises (one or more selected components of the wireless detonator assembly of the present invention.

‘Wireless detonator assembly’—refers in general to an assembly encompassing a detonator, most preferably an electronic detonator (typically comprising at least a detonator shell and a base charge) as well as wireless signal receiving and processing means to cause actuation of the base charge upon receipt by said wireless detonator assembly of a wireless signal to FIRE from at least one associated blasting machine. For example, such means to cause actuation may include signal receiving means, signal processing means, and a firing circuit to be activated in the event of a receipt of a FIRE signal. Preferred components of the wireless detonator assembly may further include means to wirelessly transmit information regarding the assembly to other assemblies or to a blasting machine, or means to relay wireless signals to other components of the blasting apparatus. Other preferred components of a wireless detonator assembly will become apparent from the specification as a whole. The expression “wireless detonator assembly” may in very specific embodiments pertain simply to a wireless signal relay device, without any association to an electronic delay detonator or any other form of detonator. In such embodiments, such relay devices may form wireless trunk lines for simply relaying wireless signals to and from blasting machines, whereas other wireless detonator assemblies in communication with the relay devices may comprise all the usual features of a wireless detonator assembly, including a detonator for actuation thereof, in effect forming wireless branch lines in the wireless network. A wireless detonator assembly may further include a top-box as defined herein, for retaining specific components of the assembly away from an underground portion of the assembly during operation, and for location in a position better suited for receipt of wireless signals derived for example from a blasting machine or relayed by another wireless detonator assembly.

‘Wireless’—refers to there being no physical connections (such as electrical wires, shock tubes, LEDC, or optical cables) connecting the detonator of the invention or components thereof to an associated blasting machine or power source.

‘Wireless electronic booster’—refers to in general to a device comprising a detonator, most preferably an electronic detonator (typically comprising at least a detonator shell and a base charge) as well as means to cause actuation of the base charge upon receipt by said booster of a signal to FIRE from at least one associated blasting machine. For example, such means to cause actuation may include a transceiver or signal receiving means, signal processing means, and a firing circuit to be activated in the event of a receipt of a FIRE signal. Preferred components of the wireless booster may further include means to transmit information regarding the assembly to other assemblies or to a blasting machine, or means to relay wireless signals to other components of the blasting apparatus. Such means to transmit or relay may form part of the function of the transceiver. Other preferred components of a wireless booster will become apparent from the specification as a whole. Further examples of wireless electronic boosters are disclosed for example in international patent publication WO 07/124,539 published Nov. 8, 2007.

‘Wireless electronic delay detonator (WEDD)’—refers to any electronic delay detonator that is able to receive and/or transmit wireless signals to/from other components of a blasting apparatus. Typically, a WEDD takes the form of, or forms an integral part of, a wireless detonator assembly as described herein.

### DETAILED DESCRIPTION OF THE INVENTION

Electronic detonators are generally known in the art with a capacity for delay time programming to the nearest millisecond. However, the inventors recognize that blasting apparatuses and corresponding detonators having even greater degrees of delay time accuracy would be desirable, for both mining and seismic applications. To this end, the inventors have developed detonators and corresponding blasting apparatuses employing such detonators, which enable execution of a blasting event with much greater degrees of accuracy compared to those of the prior art. These have presented significant and unexpected advantages over the prior art as will become apparent from the disclosure herein.

Through careful consideration, the inventors have reviewed the requirements for shockwave interference at a blast site. Shockwaves resulting from detonation of explosive charges typically travel through rock at about 2,000-6,000 m/s. Moreover, the sonic velocity of rock typically varies from about 2,500-5,500 m/s (although this may vary according to the material of the rock, rock structure, water content etc.) It follows that the shockwaves resulting from initiation of explosive charges may typically have a velocity in the order of approximately 5,000 m/s, or 5 metres per millisecond. Thus, if the timing of initiation of explosive charges is controlled to a time precision of +/−1 ms, then the propagating shockwaves passing though the rock will have a progressive shockwave front at a position that may vary by up to 5 metres relative to its ‘expected’ position in the rock.

When blasting to fragment rock, boreholes are often drilled into the rock from 0.5 m to 20 m apart (more typically 3-10 m apart) into which an explosive material is inserted. Often, the boreholes are located relative to one another in a precise manner to achieve a desired blasting pattern. However, according to the inventors' analysis, typical propagation of a shockwave (on the basis of delay time accuracy to the nearest millisecond) represents a relatively poor degree of precision relative to the spacing of the boreholes, and the charges retained therein. After all, as discussed above, at any one time the position of the shockwave may be known with an accuracy of only 10 metres (+/−5 metres) from an ‘expected’ position, and yet the boreholes are often located closer than 10 metres from one another. It follows that precise interference of shockwaves from adjacent or nearby boreholes, in a calculated manner, is difficult or impossible to achieve with present technology involving delay timing to the nearest millisecond.

In light of the above, the inventors recognize the importance of shockwave interference, and importantly the need for control of such interference through much more precise control of delay times for detonator initiation. With delay time accuracy to then nearest millisecond, it is difficult or impossible to regulate shockwave interference between adjacent boreholes just a few metres apart. A much greater degree of delay time accuracy would be required if more precise and regulated shockwave interference is to be achieved. If a blast operator wishes to achieve shockwave interference of shockwaves just 2-3 metres from a borehole, it is necessary to control and have knowledge of a position of a shockwave emanating from an adjacent borehole with an accuracy of less than 1 metre, preferably less than 0.5 m. In turn, this requires an ability to regulate delay times for detonators at the blast site with an accuracy of 0.1 ms or better. Indeed, in certain explosives engineering applications with close-spaced blastholes, such as tunnelling, it would be preferable to be able to control the position of shockwaves within 10 cm.

The invention thus provides blasting apparatuses, and corresponding methods for blasting, that involve the use of detonators capable of being programmed with delay times selectable to an accuracy of about 0.1 ms or better. Such apparatuses and methods present significant advantages. For example, in the field of mining it is desirable to achieve fragmentation of rock, preferably with simultaneous movement of fragmented rock in a manner suited for subsequent recovery and collection of the fragmented rock at the blast site. It is thus desirable for the rock to be fragmented sufficiently so that a majority of the fragmented rock can be loaded directly onto transport vehicles without prior need for further processing or fragmentation. To this end, the invention permits improved interference of shockwaves at a blast site for improved rock fragmentation. For example, detonators and their corresponding explosive charges may be arranged at the blast site into groups, with perhaps only a few metres distance between adjacent boreholes of a single group. The boreholes in a group may be arranged somewhat randomly for example within a limited area, or may be arranged in a more definite fashion, for example in a row. In any event, detonators associated with the boreholes (and explosive charges therein) may be programmed with delay times so that adjacent detonators (i.e. pairs of detonators that are closer to one another than to other detonators in the group) actuate simultaneously, or nearly simultaneously, upon receipt of a command signal to FIRE from an associated blasting machine. For example, the detonators arranged in a row of boreholes may be programmed so that each detonator in the row actuates 0.1 ms following actuation of a previous detonator in the row. In this way, the row of detonators may actuate such that each detonator is initiated at a different time to all other detonators in the row, but all detonators fire within a very short time window, perhaps less than one or only a few milliseconds in length. Detonators and their associated explosive charges in other groups at the blast site (e.g. other rows) may be caused to actuate at the same time, or within an overlapping time window, as the first group. Alternatively, the other groups may actuate perhaps several milliseconds apart from the first (or other) groups to help reduce unwanted ground vibrations. In any event, the timing of detonator actuations with a delay time accuracy of 0.1 ms or better achieves excellent shockwave interference between adjacent and/or nearby explosive charges helping to achieve dramatic improvements in rock fragmentation and/or movement.

Other embodiments of the apparatuses and methods of the invention may be applied to seismic prospecting. Typically, seismic prospecting involves the initiation of explosive charges to cause shockwaves to travel through the ground, rock and subterranean structures. Subsequent monitoring of the interaction of the shockwaves with subterranean layers or structures, including receipt of shockwaves that have been reflected, refracted or otherwise deflected by such layers or structures, or interfaces therebetween, can provide seismic prospectors with valuable information. For example, such information may permit seismic ‘mapping’ to investigate locations of mineral, oil, or gas deposits beneath the ground or beneath the sea.

Typically, seismic mapping involves the use of two (possibly more) explosive charges that are detonated simultaneously, but spatially distanced from one another. The interaction of two sets of shockwaves with one another, as well as with subterranean structures and layers, further enhances the quality and quantity of data available for analysis. In effect, the subterranean structures and layers under the same area of land (or sea) are “viewed” from more than one angle or orientation. For example, an explosive charge may be actuated just to the north of an area under study, with receipt of signals by a receiver just to the south of the area. Simultaneously, an explosive charge may be actuated just to the south of the same area under study, with receipt of signals by a receiver just to the north of the area. Comparison and correlation of the data from each “viewpoint” of the study area, may improve the overall quality of the seismic analysis, may permit dismissal of data anomalies, and reduction of noise.

The interaction of shockwaves during seismic analysis can provide valuable information, and enrich the quality of data available, particularly when the interaction involves shockwaves from spaced-apart explosive charges. However, to date analysis of shockwave interaction has only been practical if the shockwaves are derived from explosive charges that initiate simultaneously. In the field, explosive charges for seismic prospecting may be located many metres, perhaps many hundreds of metres, from one another. Even with millisecond accuracy for delay times (as permitted by electronic blasting systems known in the art), regulation of shockwave interaction has been extremely difficult to achieve or predict unless the explosive charges are initiated at precisely the same time. The use of delay times, to delay one explosive charge compared to another, by one or multiple milliseconds is impractical since the relative positions of the shockwaves derived from each explosive charge can only be estimated with very limited accuracy. Thus, the resulting seismic data is only of limited use, since the geologist undertaking the study cannot be certain how or where the shockwaves from different sources interact in the subterranean environment.

Here, the present invention, at least in preferred embodiments, presents significant advantages for seismic prospecting. The apparatuses and methods of the invention permit explosive charges to be actuated within a delay time accuracy of about 0.1 ms, or even better in some cases. In this way, actuation of a first explosive charge may be followed, for example, by actuation of a second explosive charge located say 100 m from the first explosive charge with a delay time of 0.16 ms between the explosive charges. The geologist, using an appropriate receiver, together with data retrieval and analysis tools, would then be able to interpret the resulting seismic data, secure in the knowledge of the precise delay time that gave rise to the data. If required, the seismic tests could then be repeated using the same 100 m distance and 0.16 ms delay time between the explosive charges to confirm the initial data. Alternatively, the seismic test could be repeated but with slightly altered parameters. For example, the first explosive charge could be initiated 0.16 ms after the second explosive charge. Alternatively, a series of seismic tests could be conducted with the same explosive charge, located the same 100 m distance apart, but with 0 ms, 0.2 ms, 0.4 ms, 0.6 ms, 0.8 ms, 1.0 ms, 1.2 ms. 1.4 ms, 1.6 ms, 1.8 ms, and 2.0 ms apart. The resulting data, and correlation thereof, provides a greater depth of information and a much more accurate “picture” of subterranean layers and structures. Computer-based resolution and comparison of the total raw seismic data, via well known algorithms, permits significance advances in the quality of data analysis, by virtue of the use of blasting apparatuses and methods, capable of firing detonators (and actuating associated explosive charges) with a delay time accuracy of 0.1 ms or better. Any skilled artisan will recognize that, for the purposes of seismic prospecting, a wide range of seismic tests could be conducted using very specific delay times between two or more detonators at the blast site. These delay times, and the extent of tests conducted, would depend upon prevailing conditions, subterranean layers and structure, through ground velocity of shockwaves, and other variables at the blast site. Therefore, a skilled operator may be required to tailor the use of the blasting apparatuses and methods of the invention to the specific needs of the test site.

For clarification, any of the embodiments of the blasting apparatuses and corresponding methods of the present invention disclosed herein may involve any means for communicating between each blasting machine and each detonator or detonator assembly. For example, this includes ‘traditional’ wired communication involving for example the use of electrical wires, or non-electrical physical connection such as shock tube or low-energy detonating cord. In other embodiments, the invention encompasses blasting apparatuses and corresponding methods that employ wireless communication means to transmit and receive wireless communication signals, including programming and/or command signals, between each blasting apparatus and each detonator. Such wireless signals may involve electromagnetic energy such as radio waves, or alternatively may involve laser light, or acoustic means. Typically, but not necessarily, blasting machines may communicate wirelessly with a wireless detonator assembly comprising a detonator together with other components suitable for receipt, processing, and optionally transmission, of wireless signals. Such other components may be located near or adjacent the detonator, or may be housed within a “top-box” adapted to be located at or above the surface of the ground, for example when the detonator is located down a borehole in rock at the blast site. Examples of wireless blasting apparatuses, and components thereof, that are known in the art include those disclosed in WO 2006/047823 published May 11, 2006, WO 2006/076777 published Jul. 27, 2006, WO 2006/096920 published Sep. 21, 2006, and U.S. patent applications 60/795,569 and 60/795,568 filed Apr. 28, 2006 and Jun. 14, 2006 respectively (together with a corresponding international patent application filed Apr. 27, 2007) all of which are incorporated herein by reference.

The following examples illustrate preferred embodiments of the invention, and are in no way intended to be limiting with respect to the broadest embodiments of the invention as disclosed herein, or as claimed.

### EXAMPLE 1

### Blasting Apparatus with High Accuracy

In one preferred embodiment of the invention there is provided a blasting apparatus for executing a blast plan for at least two detonators each programmable with a blasting delay time selectable to an accuracy of about 0.1 ms or better. In this embodiment the blasting apparatus comprises: at least one blasting machine for communicating at least one command signal to at least two associated detonators, wherein the command signal(s) may include at least including a FIRE signal to fire or initiate the detonators. The blasting apparatus may comprise: at least two detonators, each comprising:

i) a base charge;

ii) a firing circuit selectively connectable to the base charge;

iii) energy storage means for storing energy for initiation of the base charge via the firing circuit;

iv) an oscillator having a fixed and stable or calibratable frequency of at least about 10 kHz;

v) memory means for storing a delay time corresponding to a number of counts of the oscillator;

vi) a receiver for receiving the at least one command signal from the blasting machine;

whereby upon receipt by the receiver of the FIRE signal, the oscillator commences a count down of the number of counts, and upon completion of the countdown the energy storage means discharges the energy stored therein into the firing circuit to initiate the base charge. In this way, each detonator comprises an oscillator capable of counting down a delay time with a degree of accuracy of about 0.1 ms or greater. For example, if the oscillator has a frequency of precisely 10 kHz and a delay time of 3.6 ms is required, then the oscillator (following receipt of a command signal to FIRE) counts 36 oscillator counts before energy is discharged into the firing circuit to fire the base charge. If the oscillator has a frequency of 20 kHz, then 72 oscillator counts may be required to achieve the same delay time. Preferably, the detonator includes means to assess an oscillator frequency, optionally recalibrate the oscillator if required, and calculate a number of oscillator counts suitable to achieve a desired delay time.

The oscillator may take any form suitable to achieve high frequency rates such as 10 kHz. For example, an oscillator may take the form of any clock, crystal device, or ceramic oscillator. Preferably, the oscillator may be capable of a frequency greater than 20 kHz or greater than 40 kHz, thereby further improving the accuracy of delay time programming and execution. In especially preferred embodiments, the oscillator may have a frequency of up to or more than about 100 kHz, so that corresponding oscillator counts may permit delay time accuracy of within 0.01 ms to be achieved.

Each detonator may have a calibrated oscillator and pre-programmed delay time established upon manufacture in the factory, or at least prior to placement at the blast site. However, in preferred embodiments of the invention each detonator may be individually programmable with a delay time after placement at the blast site, and may include conversion means to convert each delay time to a required number of counts to achieve the desired delay time following receipt by the detonator of a command signal to FIRE. For example a delay time for each detonator may be transmitted to each detonator by the at least one blasting machine via either wired or wireless communication.

Alternatively, an associated blasting machine may calculate, for each detonator, according to a frequency of each oscillator associated with each detonator, a number of oscillator counts required to execute a desired delay time for each detonator, and may transmit each required number of oscillator counts to each detonator. In still further embodiments of the invention, a blasting apparatus may further include a portable logging device suitable for communication via short range wired or wireless communication with each detonator positioned at the blast site, to program each detonator with its corresponding delay time. Such logging devices are well known in the art. In preferred embodiments, the portable logging device may calculate, for each detonator, according to a frequency of each oscillator associated with each detonator, a number of oscillator counts required to execute a desired delay time for each detonator, and transmit each number of oscillator counts to each detonator.

The detonators receive command signals from at least one blasting machine, wherein such signals include at least one signal to FIRE the detonators. Preferably, the command signals, and in particular the command signal to FIRE, are transmitted to the detonators simultaneously. For example, the command signal to FIRE may be a single signal broadly transmitted on one occasion by a blasting machine, for receipt by all of the detonators at the blast site. The detonators may then receive the signal simultaneously, or virtually simultaneously, depending upon their proximity to the blasting machine and/or their communication route with the blasting machine. In this way, simultaneous or near simultaneous receipt of the signal to FIRE by all detonators enables commencement by each detonator of countdown of its respective programmed number of oscillator counts, resulting in execution of the blasting event in accordance with the pre-programmed detonator delay times.

### EXAMPLE 2

### Detonator with High Accuracy Timing of Delay Time Actuation

In other embodiments, the invention also encompasses detonators or detonator assemblies for use as a component of the blasting apparatuses previously described. Such detonators or detonator assemblies are programmable to an accuracy of about 0.1 ms or better, and may comprise:

i) a base charge;

ii) a firing circuit selectively connectable to the base charge;

iii) energy storage means for storing energy for initiation of the base charge via the firing circuit;

iv) an oscillator having a fixed and stable or calibratable frequency of at least about 10 kHz;

v) memory means for storing a delay time corresponding to a number of counts of the oscillator;

vi) a receiver for receiving the at least one command signal from an associated blasting machine.

As discussed, upon receipt by the receiver of the FIRE signal from an associated blasting machine, the oscillator commences a count down of the number of counts, and upon completion of the countdown the energy storage means discharges the energy stored therein into the firing circuit to initiate the base charge. In this way, the detonator may be programmed with a delay time having a temporal resolution corresponding to the frequency of the oscillator—i.e. delay times may be programmed with a temporal resolution of 0.1 ms or less.

### EXAMPLE 3

### Method of Blasting with High Accuracy Timing of Detonator Actuation

The invention further encompasses various methods of blasting, either for mining and rock fragmentation, or for seismic prospecting, that generally involve the blasting apparatuses of the invention. For example, one preferred method involves the steps of:

(1) providing a blasting apparatus of the invention;

(2) placing the at least two detonators at the blast site each in association with an explosive charge;

(3) programming the at least two detonators with delay times selectable to an accuracy of about 0.1 ms or better, the delay times being stored in each memory means as a number of counts for each corresponding oscillator;

(4) transmitting a command signal to FIRE from each of the at least one blasting machine to the at least two detonators, thereby causing each oscillator to count down its respective number of counts upon completion of which an associated base charge is initiated;

wherein steps (2) and (3) may be performed in any order or simultaneously.

The programming of the detonators with delay times may be achieved by any suitable means either upon factory manufacture of the detonators, or before or after placement at the blast site. Moreover, the method of command signal transmission from the blasting machine(s) to the at least two detonators may be achieved via any suitable means including wire transmission or wireless transmission. Although step 3 specifies an accuracy of about 0.1 ms or better, the accuracy of delay time programming and execution may be even better than 0.1 ms, for example 0.05 ms or better, or 0.01 ms or better, depending upon the clocks available.

### EXAMPLE 4

### Apparatus for Seismic Prospecting

Specific to embodiments for seismic prospecting, the invention provides in still further preferred embodiments for a seismic assessment apparatus for seismic assessment of subterranean geology or structure, the apparatus including:

(a) at least one blasting machine for communicating at least one command signal to at least one associated detonator, at least including a FIRE signal;

(b) at least one detonator programmable to an accuracy of about 0.1 ms or better, each comprising:
i) a base charge;
ii) a firing circuit selectively connectable to the base charge;
iii) energy storage means for storing energy for initiation of the base charge via the firing circuit;
iv) an oscillator having a fixed and stable or calibratable frequency of at least about 10 kHz;
v) memory means for storing a delay time corresponding to a number of counts of the oscillator;
vi) a receiver for receiving the at least one command signal from the blasting machine;

whereby upon receipt by the receiver of the FIRE signal, each oscillator commences a count down of the number of counts, and upon completion of the countdown the energy storage means discharges the energy stored therein into the firing circuit to initiate the base charge, so that initiation of the at least one detonator causes shockwaves through or incident to the subterranean geology or structure, as well as shockwaves reflected or refracted by the subterranean geology or structure, the shockwaves optionally interfering with one another in accordance with a relative time of initiation of the detonators; and

(c) at least one receiver for receiving the shockwaves transmitted through or incident to the subterranean geology or structure, or shockwaves reflected or refracted by the subterranean geology or structure, thereby to permit collation of data indicative of the subterranean geology or structure. If more than one detonator is present, each detonator may be programmed to initiate at a different time to some or all other detonators in the blasting apparatus, the times being known with a significant degree of accuracy, such that a position of shockwaves emanating from explosive charges is substantially known for the purposes of data collection and analysis.

In preferred embodiments, at least two detonators may be delineated into at least a first set of at least one detonator, and a second set of at least one detonator, so that the detonators within any particular set initiate at different times spaced temporally close together. In this way, resultant shockwaves from initiation of detonators within a set may interfere with one another prior to dissipation. In contrast, detonators in different sets may initiate at times sufficiently temporally spaced such that resultant shockwaves from detonators in different sets substantially dissipate without interference. For example, the first set may comprise two detonators that initiate at different times spaced X ms apart but being sufficiently close so that resultant shockwaves interfere with one another. The second set comprises two detonators that initiate at different times spaced Y ms apart being sufficiently close so that resultant shockwaves interfere with one another. However, since X and Y are different a more complex set of data may be obtained indicative of an alternative degree or pattern of shockwave interference. Thus, the overall ‘picture’ developed by computer-analysis of the received data can be better clarified.

### EXAMPLE 5

### Method for Seismic Prospecting

The invention also encompasses corresponding methods for seismic analysis of subterranean geology or structure. In preferred embodiments, such methods may comprise the steps of:

(1) providing a seismic assessment apparatus of the invention;

(2) placing the at least two detonators at the blast site;

(3) programming the at least two detonators with delay times selectable to an accuracy of about 0.1 ms or better, the delay times being stored in each memory means as a number of counts for each corresponding oscillator;

(4) transmitting a command signal to FIRE from each of the at least one blasting machine to the at least two detonators, thereby causing each oscillator to count down its respective number of counts upon completion of which an associated base charge is initiated;

(5) collecting data via the at least one receiver, corresponding to the shockwaves transmitted through or incident to the subterranean geology or structure, and/or shockwaves reflected or refracted by the subterranean geology or structure indicative of the subterranean geology or structure;

wherein steps (2) and (3) may be performed in any order or simultaneously.

Steps 2 to 5 may also be repeated, not necessarily sequentially, but with different delay times between detonators relative to one another, to achieve alternative data sets for the shockwave interaction with the subterranean structure and geology.

It should also be noted that the apparatuses and methods of the present invention may be used independent to, or in conjunction with, other methods for blasting that are known in the art, including but not limited to International Patent Publication WO 2005/124,272 published Dec. 29, 2005, and Canadian Patent Application 2,306,536 published Oct. 23, 2000, both of which are incorporated herein by reference.

The blasting apparatuses, detonators, and methods of the present invention have numerous useful applications. These present advantages for improved blasting techniques, or improved blasting results, in many different scenarios. The following examples illustrate merely a few such scenarios, and explain how in different blasting environments the apparatuses, detonators and methods of the present invention may be employed in the field.

### EXAMPLE 6

### “Smooth-Wall” Underground Blasting

Under specific circumstances, it may be desirable to conduct blasting for the purposes of obtaining an underground cavern or chamber such as, for example, a underground repository to store, preserve or secure therein any type of material, including for example biological or waste materials. The underground blasting of rock to create such underground caverns requires the use of specific blasting techniques such as those described for example in Chapter 7 of Applied Explosives Technology for Construction and Mining by Stig O. Olofsson (pub. APPLEX, Sweden, 1988), and Chapter 9 of Rock Blasting and Explosives Engineering by Per-Anders Persson et al. (pub. CRC Press, USA, 1994), which are incorporated herein by reference.

Typically, it is desirable to insert boreholes closer together in the perimeter zone of rock to be blasted (sometimes referred to as the “contour holes”), so that the fragmentation of the rock results in a relatively smooth internal surface to the cavern thus formed. With existing technology, it is very difficult to achieve or regulate shockwave interference, especially when the explosive charges in adjacent or nearby boreholes are positioned so close together. Even detonator delay time accuracies in the millisecond range provide insufficient accuracy. However, the present invention affords significant improvements in this regard. With sub-millisecond timing of delay times for detonator actuation it is possible to program adjacent electronic detonators located in adjacent boreholes to initiate just a fraction of a millisecond apart. This enables efficient shockwave interference between the closely spaced boreholes, with improved rock fragmentation. In addition, ground vibrations can be more carefully monitored and reduced. As a result, the present invention permits the production of underground caverns having internal surfaces and sub-surface structures with improved integrity and form.

### EXAMPLE 7

### Blasting for Tunnelling

Blasting techniques for tunnelling sometimes require special consideration. Often, tunnelling through rock is carried out beneath urban areas, for example for the purposes of creating a tunnel for urban transportation (e.g. for vehicles, subway trains etc.) When blasting beneath urban areas, special care must be taken to avoid ground vibrations which could damage existing infrastructure, including communications conduits, as well as water and gas pipelines. The present invention, at least in selected embodiments, presents significant advantages in this regard.

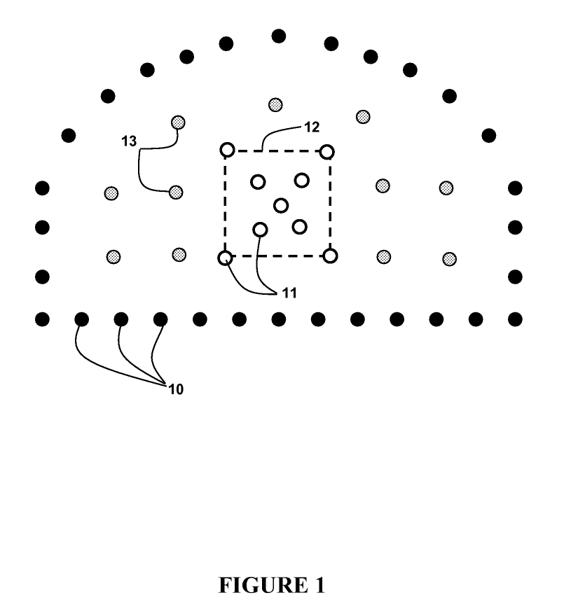

FIG. 1 schematically illustrates a front elevational view of a section of rock to be blasted for the purpose of extending a tunnel in a direction perpendicular to the page. Each small black circle 10 represents a perimeter borehole in the rock that is positioned about the perimeter of the rock to be blasted. Note that these boreholes 10 are located quite close together, perhaps 10-30 cm apart. As discussed with reference to Example 6, the reason for this is known in the art—to form an internal surface to the tunnel that is relatively well defined. The apparatuses, detonators and methods of the present invention, which involve sub-millisecond timing of electronic detonators, permit significant improvements in the fragmentation of the rock located between the perimeter boreholes 10, thereby to achieve a tunnel with a smoother, improved and more secure internal surface. Moreover, by careful regulation of detonator actuation through sub-millisecond delay times, unwanted ground vibrations can be substantially reduced, thereby helping to reduce the possibility of damage to surrounding urban infrastructure.

In preferred embodiments of the apparatuses and methods of the present invention, wireless detonator assemblies or wireless electronic boosters, which contain the required components for sub-millisecond delay timing, are used for underground tunnelling. Such wireless detonator assemblies or wireless electronic boosters are particularly suited to automated mining techniques, for example involving robotic placement of explosives underground. Wireless detonators assemblies and wireless electronic boosters are described, for example, in WO 2006/047823 published May 11, 2006, WO 2006/076777 published Jul. 27, 2006, WO 2006/096920 published Sep. 21, 2006, and WO 2007/124539 published Nov. 8, 2007, all of which are incorporated herein by reference.

Also shown in FIG. 1 are additional boreholes 11 shown as white circles defining and located in a “cut” region 12. Typically, but not necessarily, the detonators and explosive charges in this cut region are actuated first to provide a hollowed-out portion in the rock in the blast zone. The hollowed-out portion subsequently provides a space to at least in part receive fragmented rock generated by subsequent actuation of explosives in perimeter boreholes 10, as well as actuation of explosives in intermediary boreholes 13 shown as grey circles.

### EXAMPLE 8

### General Perimeter Blasting

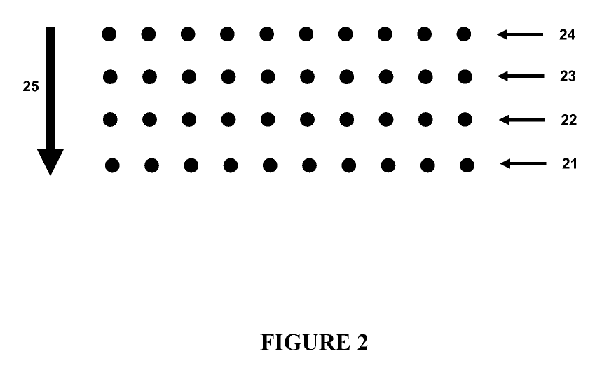

General perimeter blasting includes above-ground or surface blasting of exposed rock-faces. Typically, boreholes and explosive charges retained therein are arranged in rows 21, 22, 23, 24, as shown for example in FIG. 2, which shows a top-plan view of the blast site. Detonators and corresponding explosive charges in row 21 are actuated first, resulting in a fragmentation of adjacent rock and general movement of the fragmented rock in a general direction 25. Subsequently, detonators and corresponding explosive charges in row 22 may be actuated, again resulting in fragmentation of adjacent rock and movement of the fragmented rock in general direction 25. The same process may be carried out for row 23.

Row 24 may require special consideration because it will be the final row of detonators and corresponding explosive charges to be actuated, and the fragmentation of nearby rock, and movement of this fragmented rock, will result in a final wall of rock that may remain after the blasting has been completed a the blast site. It is especially important that this final wall of rock have a degree of integrity for safety reasons, and at times it may be preferred that is have a smoother and more pleasing aesthetic appearance. The blasting apparatuses, detonators and blasting methods of the present invention may, for example, be applied to the blasting of row 25 of detonators and corresponding explosive charges. The sub-millisecond timing of detonator actuation can result in improved shockwave interference between nearby or adjacent boreholes, even if the boreholes are placed close together, thus resulting in improved rock fragmentation and reduced ground vibrations. As a result the finished rock-face has improved integrity, with fewer fissures, cracks, or structural weaknesses relative to a rock-face produced by more conventional blasting techniques.

In other embodiments, the blasting apparatuses, detonators and methods of the present invention may be used to blast rock for the purposes of generating a finish rock wall adjacent a road or other transportation route. Again, the improved integrity of the rock face means that the possibility of rock falling away from the rock face and jeopardizing the safety of the road is substantially reduced.

### EXAMPLE 9

### “Pre-Split” Blasting of Rock

Pre-split blasting is known in the art (see for example Applied Explosives Technology for Construction and Mining by Stig O. Olofsson (pub. APPLEX, Sweden 1988), and Rock Blasting and Explosives Engineering by Per-Anders Persson et al. (pub. CRC Press, USA, 1994), which are incorporated herein by reference). Briefly, the technique includes performing a series of preliminary, small blasts effectively to perforate or weaken a region of rock just prior to a main, larger blasting event. For example, a region of rock may be weakened by a series of pre-split blasting along a line extending along a boundary or perimeter of a region of rock to be fragmented. This technique may be particularly useful to fragment a region of rock whilst substantially avoiding damage to a region of adjacent rock. Pre-split blasting is discussed, for example, in Applied Explosives Technology for Construction and Mining by Stig O. Olofsson (pub. APPLEX, Sweden 1988). Pre-split blasting is also used, for example, in the formation of rock-faces adjacent a transportation route such as a road.

Traditionally, detonators in a single pre-split blasting event (e.g. to form one weakness or perforation in the rock) may be connected via detonating cord, without significant regard to the relative timing of detonator actuation. The blasting apparatuses, detonators and corresponding methods of the present invention present opportunities for improvements in pre-split blasting through careful programming of detonators with delay-times having a sub-millisecond degree of accuracy. Such detonators may be spatially organized and programmed with delay times that are temporally separated by a fraction of a millisecond, thereby to achieve improved interference of shockwaves emanating from the boreholes, resulting in improved rock fragmentation within a specific, limited region of the rock for the pre-split blast.

### EXAMPLE 10

### Seismic Applications

As previously discussed, specific embodiments of the present invention are suitable for use in seismic analysis. Traditionally, such analysis involves the actuation of explosive charges located several, perhaps hundred of meters apart connected via lengthy physical connections such as wires or detonating cord. Preferred embodiments of the present invention employ blasting apparatuses, detonators, and corresponding methods that involve wireless communication between the detonators/explosive charges for seismic prospecting, and an associated blasting machine. In one aspect, this avoids the demise and wastage of physical wires or detonating cord traditionally used during a seismic blasting event. Moreover, seismic analysis techniques typically involve the use of explosive charges. Indeed, the explosive charges for seismic prospecting may have such a low capacity that damage to any top-box or similar device located above or near a surface of the ground may be at least substantially avoided, which further highlights the usefulness of wireless devices for seismic blasting.

### EXAMPLE 11

### Oil and Gas Prospecting

Seismic prospecting for deposits of oil and gas is yet another field of the art that benefits from the present invention. As discussed, such prospecting may involve the actuation of explosive charges, followed by “listening” for vibrations and signals resulting from detonator actuation, but reflected or refracted by subterranean layers, structures, and deposits.

Traditionally, such seismic prospecting has involved the use of regular electric detonators connected via leg-wires. Such electric detonators do not include their own capacitor, but rather rely upon their attached signal lines for a firing current. Typically, a signal is sent to fire such detonators simultaneously. However, in reality only near simultaneous detonator actuation is achieved. The detonators may be located a significant distance apart, and varying resistances in the connecting wires and detonator fuseheads can result in some variability in the timing of actuation of the detonators relative to one another.

The blasting apparatuses, detonators, and corresponding methods of the present invention afford new opportunities for seismic prospecting, for example for oil and gas deposits. According to the present invention, detonators may be programmed with such a high degree of accuracy as to substantially ensure that detonators are actuated virtually simultaneously, and the margin for error (for example by unintentional variation in the timing of detonator actuation) is significantly reduced. Importantly, a more complex set of seismic data may be obtained and correlated, for example by repeating a seismic analysis with slight but intentional variances in the timing of detonator actuation, or indeed the order of detonator actuation, with an unprecedented degree of accuracy with regard to detonator delay times.

### EXAMPLE 12

### Improved Efficiency of Rock Fragmentation

Blasting techniques often involve the use of rows of boreholes in rock, into which are placed detonators together with their associated explosive charges. It is known in the art that the efficiency and extent of rock fragmentation may vary according to the delay between adjacent holes in a row. For example, if the delay time between detonators in adjacent holes is 30 ms, and the distance between the holes is 10 m, then the specific delay between the holes in a row is calculated as 3 ms/m.

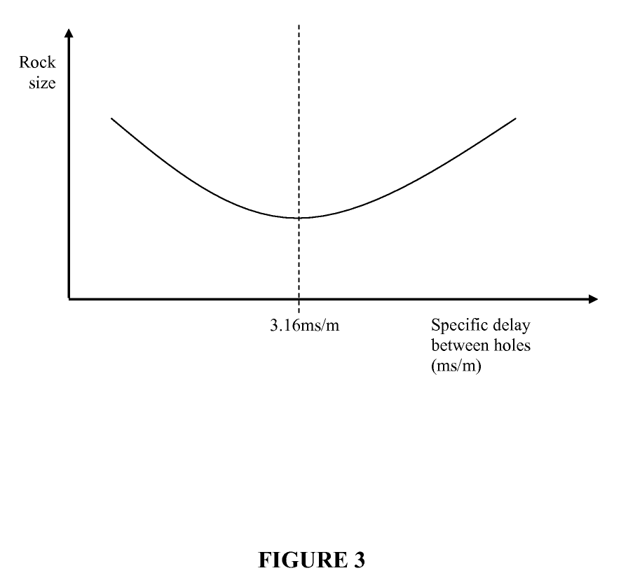

FIG. 3 schematically illustrates a typical relationship between fragmented rock size (y-axis) and specific delay (x-axis). The nature of the relationship can depend upon the blast site conditions, and the rock to be blasted. However, from FIG. 3 it can be seen that an optimum specific delay can exist at which maximum rock fragmentation (i.e. minimum rock size) is achieved. The blasting apparatuses, detonators, and methods of the present invention enable improved optimization of rock fragmentation, since they permit detonator delay times to be programmed with a sub-millisecond degree of accuracy. In the example above, suppose the specific delay between rows of holes is 3 ms/m, but the preferred optimum delay for maximum fragmentation of rock is calculated as 3.16 ms/m. In accordance with the present invention, the specific delay between the rows can be adjusted to the optimum level by altering the delay times programmed into the detonators of the adjacent rows, from 30 ms to 31.6 ms. This level of optimization at the blast site is now achievable by virtue of the advantages of the present invention, and in particular the capacity for the detonators to be programmed with delay times having a sub-millisecond degree of accuracy.

Whilst the invention has been described with specific reference to blasting apparatuses and methods, for both mining and seismic applications, other apparatuses and methods other than those described are with the scope of the invention as described and claimed.

1. A blasting apparatus, for executing a blast plan for at least two detonators each programmable with a delay time selectable to an accuracy of about 0.1 ms or better, the blasting apparatus comprising:
(a) at least one blasting machine for transmitting at least one command signal to at least two associated detonators, at least including a FIRE signal;
(b) at least two detonators, each comprising:
i) a base charge;
ii) a firing circuit selectively connectable to the base charge;
iii) energy storage means for storing energy for initiation of the base charge via the firing circuit;
iv) an oscillator having a fixed and stable or calibratable frequency of at least about 10 kHz;
v) memory means for storing a delay time corresponding to a number of counts of said oscillator;
vi) a receiver for receiving said at least one command signal from said blasting machine;
whereby upon receipt by said receiver of said FIRE signal, said oscillator commences a count down of said number of counts, and upon completion of said countdown said energy storage means discharges said energy stored therein into said firing circuit to initiate said base charge.

2. The blasting apparatus of claim 1, wherein said oscillator of each detonator has a frequency of at least 20 kHz.

3. The blasting apparatus of claim 1, wherein said oscillator of each detonator has a frequency of at least 40 kHz.

4. The blasting apparatus of claim 1, wherein each detonator is individually programmable with a delay time after placement at the blast site, and includes conversion means to convert each delay time to said number of counts.

5. The blasting apparatus of claim 4, wherein a delay time for each detonator is transmitted via wired or wireless connection to each detonator by said at least one blasting machine.

6. The blasting apparatus of claim 5, wherein the blasting machine calculates, for each detonator, according to a frequency of each oscillator associated with each detonator, a number of oscillator counts required to execute a desired delay time for each detonator, and transmits each number of oscillator counts to each detonator.

7. The blasting apparatus of claim 4, wherein the apparatus further includes a portable logging device suitable for communication via wired or short range wireless communication with each detonator positioned at the blast site, to program each detonator with its corresponding delay time.

8. The blasting apparatus of claim 7, wherein the portable logging device calculates, for each detonator, according to a frequency of each oscillator associated with each detonator, a number of oscillator counts required to execute a desired delay time for each detonator, and transmits each number of oscillator counts to each detonator.

9. The blasting apparatus of claim 1, wherein said command signal to FIRE is transmitted to said at least two detonators simultaneously, and received by said at least two detonators at least virtually simultaneously, so that each countdown of each number of counts commences at least virtually simultaneously.

10. The blasting apparatus of claim 1, wherein each of the at least one command signal is a wireless command signal, and the receiver receives wireless command signals from the at least one blasting machine.

11. A detonator assembly programmable with a delay time to an accuracy of about 0.1 ms or better, the detonator assembly comprising:
i) a base charge;
ii) a firing circuit selectively connectable to the base charge;
iii) energy storage means for storing energy for initiation of the base charge via the firing circuit;
iv) an oscillator having a fixed and stable or calibratable frequency of at least about 10 kHz;
v) memory means for storing a delay time corresponding to a number of counts of said oscillator;
vi) a receiver for receiving said at least one command signal from an associated blasting machine;
whereby upon receipt by said receiver of said FIRE signal from an associated blasting machine, said oscillator commences a count down of said number of counts, and upon completion of said countdown said energy storage means discharges said energy stored therein into said firing circuit to initiate said base charge.

12. A wireless electronic booster, comprising:
the detonator assembly of claim 11, wherein said receiver receives wireless command signals from an associated blasting machine;
an explosive charge actuable upon initiation of the base charge of the detonator;
a housing for containing the detonator assembly and the explosive charge.

13. A method of blasting, comprising the steps of:
(1) providing a blasting apparatus of claim 1;
(2) placing the at least two detonators at the blast site;
(3) programming the at least two detonators with delay times selectable to an accuracy of about 0.1 ms or better, said delay times being stored in each memory means as a number of counts for each corresponding oscillator;
(4) transmitting a command signal to FIRE from each of said at least one blasting machine to said at least two detonators, thereby causing each oscillator to count down its respective number of counts upon completion of which an associated base charge is initiated;
wherein steps (2) and (3) may be performed in any order or simultaneously.

14. The method of claim 13, wherein step 4 of transmitting a command signal comprises transmitting a wireless command signal.

15. A seismic assessment apparatus for seismic assessment of subterranean geology or structure, the apparatus including:
(a) at least one blasting machine for communicating at least one command signal to at least one associated detonator, at least including a FIRE signal;
(b) at least one detonator programmable to an accuracy of about 0.1 ms or better, each comprising:
i) a base charge;
ii) a firing circuit selectively connectable to the base charge;
iii) energy storage means for storing energy for initiation of the base charge via the firing circuit;
iv) an oscillator having a fixed and stable or calibratable frequency of at least about 10 kHz;
v) memory means for storing a delay time corresponding to a number of counts of said oscillator;
vi) a receiver for receiving said at least one command signal from said blasting machine;
whereby upon receipt by said receiver of said FIRE signal, each oscillator commences a count down of said number of counts, and upon completion of said countdown said energy storage means discharges said energy stored therein into said firing circuit to initiate said base charge, so that initiation of each of the at least one detonator causes shockwaves through or incident to said subterranean geology or structure, as well as shockwaves reflected or refracted by said subterranean geology or structure, said shockwaves optionally interfering with one another; and
(c) at least one shockwave receiver for receiving said shockwaves transmitted through or incident to said subterranean geology or structure, or shockwaves reflected or refracted by said subterranean geology or structure, thereby to permit collation of data indicative of said subterranean geology or structure.

16. The apparatus of claim 15, wherein said at least one detonator comprises at least a first set of at least one detonator, and a second set of at least one detonator, so that said detonators within any set initiate at different times spaced temporally close together so that resultant shockwaves from initiation of detonators within a set interfere with one another prior to dissipation, and detonators in different sets initiate at times sufficiently temporally spaced such that resultant shockwaves from detonators in different sets substantially dissipate without interference.

17. The apparatus of claim 16, wherein the first set comprises two detonators that initiate at different times spaced X ms apart being sufficiently close so that resultant shockwaves interfere with one another, and the second set comprises two detonators that initiate at different times spaced Y ms apart being sufficiently close so that resultant shockwaves interfere with one another, wherein X and Y are different.

18. A method for seismic analysis of subterranean geology or structure, the method comprising the steps of:
(1) providing a seismic assessment apparatus of claim 15;
(2) placing the at least one detonator at the blast site;
(3) programming each of the at least one detonator with a delay time selectable to an accuracy of about 0.1 ms or better, said delay times being stored in each memory means as a number of counts for each corresponding oscillator;
(4) transmitting a command signal to FIRE from each of said at least one blasting machine to said at least one detonator, thereby causing each oscillator to count down its respective number of counts upon completion of which an associated base charge is initiated; and
(5) collecting data via said at least one shockwave receiver, corresponding to said shockwaves transmitted through or incident to said subterranean geology or structure, and/or shockwaves reflected or refracted by said subterranean geology or structure indicative of said subterranean geology or structure;
wherein steps (2) and (3) may be performed in any order or simultaneously.

19. The method of claim 18, further comprising repeating steps 2 to 5, not necessarily sequentially, using different sets of at least two detonators, each set being programmed with a unique set of delay times, thereby to collect more than one data set corresponding to said subterranean geology or structure each indicative of each unique set of delay times.

20. A method for fragmenting rock drilled with boreholes, the method comprising the steps of:
(1) inserting into each borehole an explosive material and an associated electronic detonator such that initiation of a base charge in the detonator causes detonation of the explosive material;
(2) programming each electronic detonator with a delay time having an accuracy of about 0.1 ms or better;
(3) sending a signal to all detonators to begin countdown of their programmed delay times to cause initiation of the detonators and detonation of the explosive materials in the boreholes, the delay times being programmed in such a manner that shockwaves resulting from detonation of the explosive materials interfere to cause efficient fragmentation of rock located between or near the boreholes;
wherein steps 1 and 2 may be performed in any order.
